(19) United States
(12) Patent Application Publication
(10) Pub. No.: US 2014/0211136 A1
(43) Pub. Date: Jul. 31, 2014

(54) LIQUID CRYSTAL DISPLAY DEVICE

(71) Applicant: Japan Display Inc., Minato-ku (JP)

(72) Inventors: Nobuko FUKUOKA, Tokyo (JP); Arihiro Takeda, Tokyo (JP)

(73) Assignee: Japan Display Inc., Minato-ku (JP)

(21) Appl. No.: 14/157,985

(22) Filed: Jan. 17, 2014

(30) Foreign Application Priority Data
Jan. 30, 2013 (JP) 2013-015840

(51) Int. Cl. G02F 1/1339

(52) U.S. Cl. CPC G02F 1/1339
USPC 349/106

(57) ABSTRACT

According to one embodiment, a liquid crystal display device includes a first substrate including a pixel electrode and a dummy pixel electrode, a second substrate including a light-shield layer including a first light-shield portion opposed to a position between the pixel electrode and the dummy pixel electrode, a second light-shield portion located in an active area and a third light-shield portion located in a peripheral area, a color filter opposed to the pixel electrode, and a dummy color filter opposed to the dummy pixel electrode, a first columnar spacer creating a first cell gap in the active area, and a second columnar spacer creating a second cell gap that is equal to the first cell gap in the peripheral area.

### CROSS-REFERENCE TO RELATED APPLICATIONS

This application is based upon and claims the benefit of priority from Japanese Patent Application No. 2013-015840, filed Jan. 30, 2013, the entire contents of which are incorporated herein by reference.

### FIELD

Embodiments described herein relate generally to a liquid crystal display device.

### BACKGROUND

Liquid crystal display devices have been used in various fields as display devices, etc. In the liquid crystal display device, it is important to uniformize a cell gap (the thickness of a liquid crystal layer held between a pair of substrates) of an active area which displays an image. In recent years, such a technique has been established that, as spacers for forming the cell gap, columnar spacers are selectively disposed on one of the substrates and the spacers are precisely formed with desired thickness, thereby uniformizing the cell gap.

In such a liquid crystal display device, the degree of surface asperities is greatly different between the active area where electrodes, wirings, color filters, light-shield layers, etc. are formed, and a peripheral area. Specifically, there are cases in which the structure of an underlying base layer at positions where the spacers are disposed, or the structure of the spacer-supporting side is different between the active area and the peripheral area. Thus, in the case where the spacers have uniform height, it is possible that while spacers are in contact with an opposed substrate in the active area, spacers are not in contact with the opposed substrate in the peripheral area. If the paired substrates are attached in this state, the cell gap of the peripheral area would become smaller than the cell gap of the active area. In addition, if a color filter is stacked on a light-shield layer in the peripheral area, the cell gap of the peripheral area would become greater than the cell gap of the active area. In particular, with a demand for a narrower picture frame, in a device with a small picture frame width, the difference in cell gap between the active area and the peripheral area adversely affects the cell gap at a peripheral part in the active area. As a result, there is a concern that the cell gap becomes different between the central part and peripheral part within the active area, and such a difference in cell gap would be recognized as non-uniformity in display.

In recent years, one drop fill (ODF) method has been gaining in popularity as one of manufacturing processes of liquid crystal display devices. In this ODF method, after a liquid crystal material is dispensed in a region surrounded by a sealant on an array substrate or a counter-substrate, the array substrate and the counter-substrate are attached in a vacuum state. Then, by restoring the vacuum state to an atmospheric pressure state, the paired substrates are pressurized by a pressure difference between the region surrounded by the sealant and the atmospheric pressure, and the sealant is collapsed. Thereby, a predetermined cell gap is formed. When this ODF method is applied, if a variance occurs in cell gap, an excess or deficiency of the dispensed liquid crystal material tends to occur relative to the volume of the space in which the liquid crystal material is to be sealed. Specifically, when the amount of dispensed liquid crystal material is deficient, such a problem may arise that bubbles occur in the liquid crystal layer, or the cell gap becomes locally smaller than a desired value. In addition, if the amount of dispensed liquid crystal material is excessive, the cell gap would become locally larger than the desired value. Such a problem leads to degradation in display quality or a decrease in manufacturing yield.

### BRIEF DESCRIPTION OF THE DRAWINGS

FIG. 1 is a view which schematically illustrates a structure and an equivalent circuit of a liquid crystal display panel LPN, which constitutes a liquid crystal display device according to an embodiment.

FIG. 2 is a view which schematically illustrates a cross-sectional structure including a switching element SW in one pixel of the liquid crystal display panel LPN shown in FIG. 1.

FIG. 3 is a cross-sectional view which schematically illustrates a structure including a spacer SA and a peripheral spacer SB in the embodiment, FIG. 3 showing only the structure necessary for the description.

FIG. 4 is a plan view which schematically illustrates a layout example of a light-shield layer 31 which is applicable to the embodiment.

FIG. 5 is a cross-sectional view which schematically illustrates another structure including a spacer SA and a peripheral spacer SB in the embodiment.

FIG. 6 is a cross-sectional view which schematically illustrates another structure including a spacer SA and a peripheral spacer SB in the embodiment.

### DETAILED DESCRIPTION

In general, according to one embodiment, a liquid crystal display device includes: a first substrate including a pixel electrode disposed at an outermost periphery in an active area which displays an image, a dummy pixel electrode disposed in a peripheral area outside the active area and neighboring the pixel electrode, and a first alignment film covering the pixel electrode and the dummy pixel electrode; a second substrate including a light-shield layer including a first light-shield portion located at a boundary between the active area and the peripheral area and opposed to a position between the pixel electrode and the dummy pixel electrode, a second light-shield portion located in the active area and a third light-shield portion located in the peripheral area, a color filter opposed to the pixel electrode, a dummy color filter opposed to the dummy pixel electrode, and a second alignment film opposed to the first alignment film; a first columnar spacer which is interposed between the first substrate and the second substrate in the active area, creates a first cell gap in the active area, and is formed at a position opposed to the second light-shield portion; a second columnar spacer which is interposed between the first substrate and the second substrate in the peripheral area, creates a second cell gap that is equal to the first cell gap in the peripheral area, and is formed at a position opposed to the third light-shield portion; and a liquid crystal layer held between the first substrate and the second substrate.

According to another embodiment, a liquid crystal display device includes: a first substrate including a common electrode extending over an active area which displays an image and a peripheral area outside the active area, an interlayer insulation film located above the common electrode, a pixel electrode disposed above the interlayer insulation film at an outermost periphery in the active area, a dummy pixel electrode disposed above the interlayer insulation film in the peripheral area and neighboring the pixel electrode, and a first alignment film covering the pixel electrode and the dummy pixel electrode; a second substrate including a light-shield layer including a first light-shield portion located at a boundary between the active area and the peripheral area and opposed to a position between the pixel electrode and the dummy pixel electrode, a second light-shield portion located in the active area and a third light-shield portion located in the peripheral area, a color filter opposed to the pixel electrode, a dummy color filter opposed to the dummy pixel electrode, and a second alignment film opposed to the first alignment film; a first columnar spacer which is interposed between the first substrate and the second substrate in the active area, creates a first cell gap in the active area, and is formed at a position opposed to the second light-shield portion; a second columnar spacer which is interposed between the first substrate and the second substrate in the peripheral area, creates a second cell gap that is equal to the first cell gap in the peripheral area, and is formed at a position opposed to the third light-shield portion; and a liquid crystal layer held between the first substrate and the second substrate.

According to another embodiment, a liquid crystal display device includes: a first substrate including a pixel electrode disposed at an outermost periphery in an active area which displays an image, a dummy pixel electrode disposed in a peripheral area outside the active area and neighboring the pixel electrode, and a first alignment film covering the pixel electrode and the dummy pixel electrode; a second substrate including a light-shield layer including a first light-shield portion located at a boundary between the active area and the peripheral area and opposed to a position between the pixel electrode and the dummy pixel electrode, a second light-shield portion located in the active area and a third light-shield portion located in the peripheral area, a color filter opposed to the pixel electrode, a dummy color filter opposed to the dummy pixel electrode, an overcoat layer covering the color filter and the dummy color filter, a common electrode formed on a side of the overcoat layer, which is opposed to the first substrate, and extending over the active area and the peripheral area, and a second alignment film opposed to the first alignment film and covering the common electrode; a first columnar spacer which is interposed between the first substrate and the second substrate in the active area, creates a first cell gap in the active area, and is formed at a position opposed to the second light-shield portion; a second columnar spacer which is interposed between the first substrate and the second substrate in the peripheral area, creates a second cell gap that is equal to the first cell gap in the peripheral area, and is formed at a position opposed to the third light-shield portion; and a liquid crystal layer held between the first substrate and the second substrate.

Embodiments will now be described in detail with reference to the accompanying drawings. In the drawings, structural elements having the same or similar functions are denoted by like reference numerals, and an overlapping description is omitted.

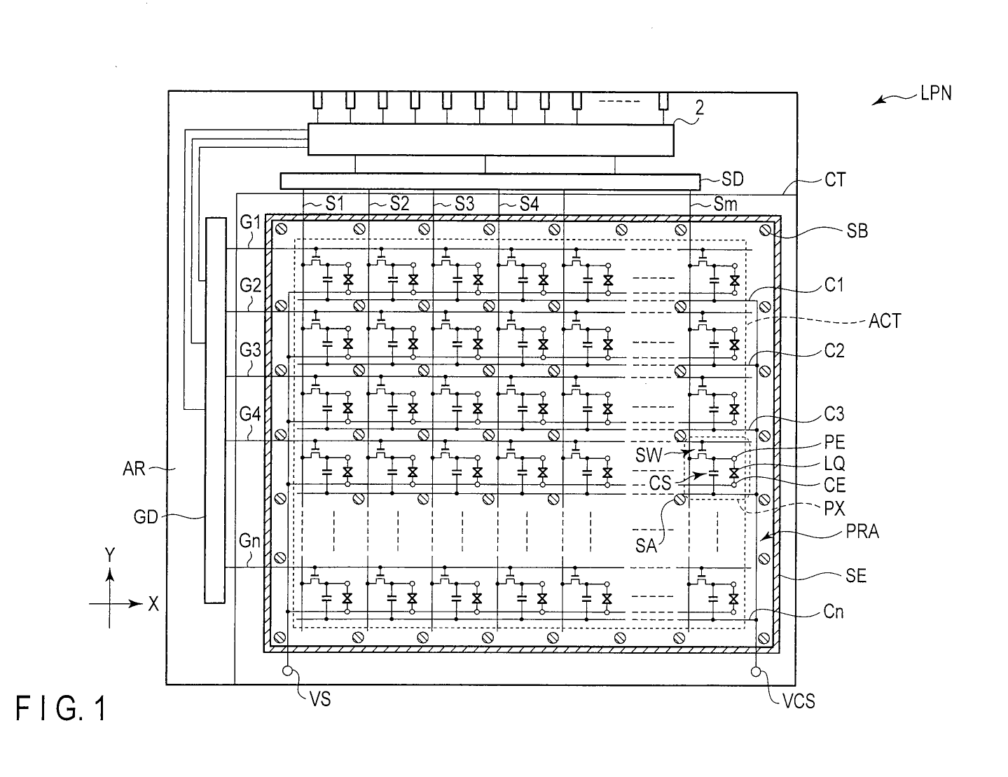

FIG. 1 is a view which schematically shows a structure and an equivalent circuit of a liquid crystal display panel LPN, which constitutes a liquid crystal display device according to an embodiment.

Specifically, the liquid crystal display device includes an active-matrix-type liquid crystal display panel LPN. The liquid crystal display panel LPN includes an array substrate AR which is a first substrate, a counter-substrate CT which is a second substrate that is disposed to be opposed to the array substrate AR, and a liquid crystal layer LQ which is held between the array substrate AR and the counter-substrate CT. The array substrate AR and counter-substrate CT are attached by a sealant SE. The sealant SE is formed, for example, in a closed-loop (i.e. continuous with no break) rectangular frame shape. The liquid crystal display panel LPN includes an active area ACT, which displays an image, in an inside surrounded by the sealant SE. The active area ACT is composed of a plurality of pixels PX which are arrayed in a matrix. A peripheral area PRA outside the active area ACT is an area surrounding the active area ACT, includes an area where the sealant SE is disposed, and is formed in a rectangular frame shape.

The array substrate AR includes, in the active area ACT, a plurality of gate lines G (G1 to Gn) and storage capacitance lines C (C1 to Cn) extending in a first direction X, a plurality of source lines S (S1 to Sm) extending in a second direction Y which crosses the first direction X, a switching element SW which is electrically connected to the gate line G and source line S in each pixel PX, and a pixel electrode PE which is electrically connected to the switching element SW in each pixel PX. A common electrode CE, which is opposed to each pixel electrode PE via the liquid crystal layer LQ, is provided, for example, on the array substrate AR, but the common electrode CE may be provided on the counter-substrate CT.

Although a description of the detailed structure of the liquid crystal display panel LPN is omitted, in a structure to which a mode mainly using a vertical electric field, such as a TN (Twisted Nematic) mode, an OCB (Optically Compensated Bend) mode or a VA (Vertical Aligned) mode, is applied, the pixel electrodes PE are provided on the array substrate AR, while the common electrode CE is provided on the counter-substrate CT. In addition, in a structure to which a mode mainly using a lateral electric field, such as an IPS (In-Plane Switching) mode or an FFS (Fringe Field Switching) mode, is applied, both the pixel electrodes PE and common electrode CE are provided on the array substrate AR.

Each of the gate lines G is led out of the active area ACT and is connected to a gate driver GD. Each of the source lines S is led out of the active area ACT and is connected to a source driver SD. Each of the storage capacitance lines C is led out of the active area ACT and is electrically connected to a voltage application module VCS to which a storage capacitance voltage is applied. The common electrode CE is electrically connected to a power supply module VS to which a common voltage is applied. For example, at least parts of the gate driver GD and source driver SD are formed on the array substrate AR, and are connected to a driving IC chip 2 which functions as a signal source necessary for driving the liquid crystal display panel LPN. In the example illustrated, the driving IC chip 2 is mounted on the array substrate AR in the peripheral area PRA of the liquid crystal display panel LPN.

The liquid crystal display panel LPN includes columnar spacers (first columnar spacers) SA which are disposed in the active area ACT, and columnar peripheral spacers (second columnar spacers) SB which are disposed in the peripheral area PRA. Each of the spacers SA and peripheral spacers SB illustrated is located in the inside surrounded by the sealant SE. Specifically, the peripheral spacers SB are located between the active area ACT and sealant SE. Each of the spacers SA and peripheral spacers SB is interposed between the array substrate AR and counter-substrate CT, and creates a predetermined cell gap between both substrates. In the meantime, the spacers SA and peripheral spacers SB are formed on an identical substrate which is either the array substrate AR or the counter-substrate CT.

In the present embodiment, the picture frame of the liquid crystal display panel LPN is narrowed, and the width of the peripheral area PRA, that is, the distance (picture frame width) from each side of the rectangular active area ACT to each side of the liquid crystal display panel LPN, is, for example, less than 1 mm.

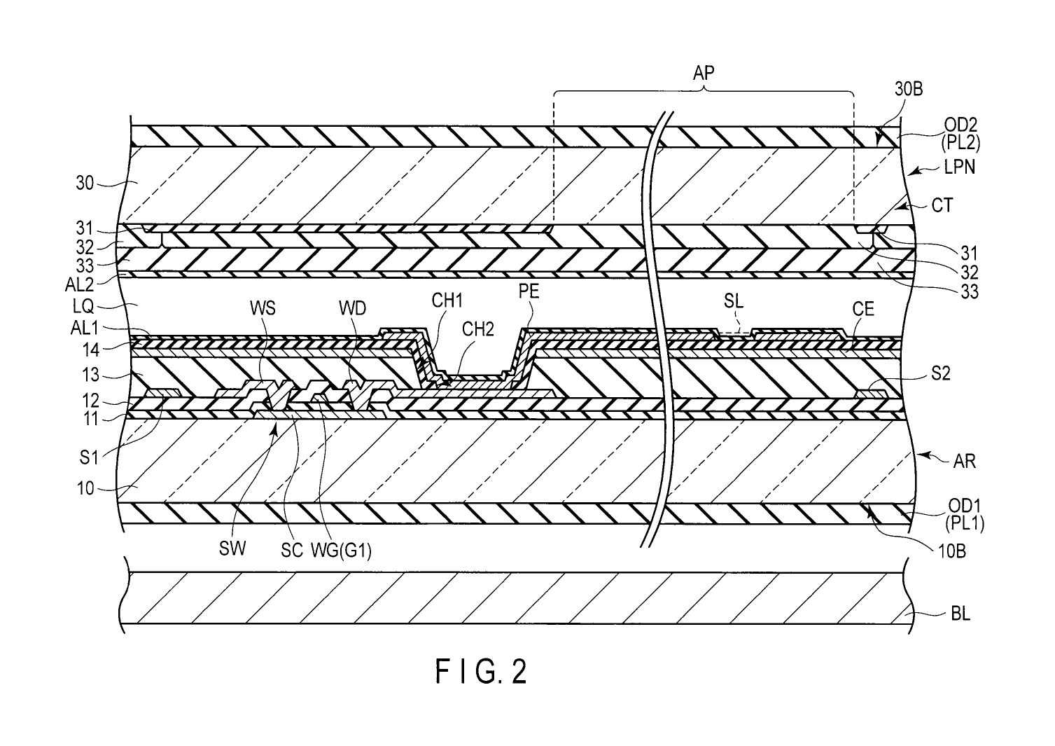

FIG. 2 is a view which schematically illustrates a cross-sectional structure including the switching element SW in one pixel of the liquid crystal display panel LPN shown in FIG. 1. A description is given of a structure example to which an FFS mode is applied.

Specifically, the array substrate AR is formed by using a first insulative substrate 10 having light transmissivity, such as a glass substrate or a resin substrate. The array substrate AR includes, on that side of the first insulative substrate 10, which is opposed to the counter-substrate CT, a switching element SW, a common electrode CE, a pixel electrode PE, a first insulation film 11, a second insulation film 12, a third insulation film 13, a fourth insulation film 14, and a first alignment film AL1.

The switching element SW illustrated in FIG. 2 is, for example, a thin-film transistor (TFT) of a top gate type. The switching element SW may be of a bottom gate type. The switching element SW includes a semiconductor layer SC which is disposed on the first insulative film 10. The semiconductor layer SC can be formed of polysilicon, amorphous silicon or an oxide semiconductor. In the example illustrated, the semiconductor layer SC is formed of polysilicon. An undercoat layer, which is an insulation film, may be interposed between the first insulation substrate 10 and the semiconductor layer SC. The semiconductor layer SC is covered with the first insulation film 11. The first insulation film 11 is also disposed on the first insulative substrate 10.

A gate electrode WG of the switching element SW is formed on the first insulation film 11, and is located immediately above the semiconductor layer SC. The gate electrode WG is electrically connected to a gate line (e.g. gate line G1) (or formed integral with the gate line G1) and is covered with the second insulation film 12. The second insulation film 12 is also disposed on the first insulation film 11. The first insulation film 11 and second insulation film 12 are formed of an inorganic material such as silicon oxide or silicon nitride.

A source electrode WS and a drain electrode WD of the switching element SW are formed on the second insulation film 12. A source line S1 and a source line S2 are similarly formed on the second insulation film 12. The source electrode WS illustrated is electrically connected to the source line S1 (or formed integral with the source line S1). The source electrode WS and drain electrode WD are put in contact with the semiconductor layer SC via contact holes penetrating the first insulation film 11 and second insulation film 12. The switching element SW with this structure, as well as the source line S1 and source line S2, is covered with the third insulation film 13. The third insulation film 13 is also disposed on the second insulation film 12. A first contact hole CH1, which penetrates to the drain electrode WD, is formed in the third insulation film 13. The third insulation film 13 is formed of, for example, a transparent resin material.

The common electrode CE is formed on the third insulation film 13. Incidentally, the common electrode CE does not extend to the first contact hole CH1. The common electrode CE is formed of a transparent, electrically conductive material such as indium tin oxide (ITO) or indium zinc oxide (IZO). The fourth insulation film 14 is disposed on the common electrode CE. Although not illustrated, the fourth insulation film 14 is also disposed on the third insulation film 13. A second contact hole CH2, which penetrates to the drain electrode WD, is formed in that part of the fourth insulation film 14, which covers the first contact hole CH1. The fourth insulation film 14 functions as an interlayer insulation film which is located between the common electrode CE and the pixel electrode PE, has a less thickness than the third insulation film 13, and is formed of, for example, silicon nitride.

The pixel electrode PE is formed in an island shape on the fourth insulation film 14 and is opposed to the common electrode CE. In addition, a slit SL is formed in the pixel electrode PE at a position opposed to the common electrode CE. The pixel electrode PE is electrically connected to the drain electrode WD of the switching element SW via the first contact hole CH1 and second contact hole CH2. This pixel electrode PE is formed of a transparent, electrically conductive material such as ITO or IZO. The pixel electrode PE is covered with the first alignment film AL1. The first alignment film AL1 also extends over the slit SL, and covers the fourth insulation film 14.

On the other hand, the counter-substrate CT is formed by using a second insulative substrate 30 with light transmissivity, such as a glass substrate or a resin substrate. The counter-substrate CT includes, on that side of the second insulative substrate 30, which is opposed to the array substrate AR, a light-shield layer 31, color filters 32, an overcoat layer 33 and a second alignment film AL2.

The light-shield layer 31 partitions each pixel PX in the active area ACT, and forms an aperture portion AP. The light-shield layer 31 is opposed to wiring portions, such as gate lines G, source lines S and switching elements SW, which are provided on the array substrate AR. Although not illustrated, the light-shield layer 31 is also formed in the peripheral area.

The color filter 32 is formed in the aperture portion AP, and a part thereof also extends over the light-shield layer 31. The color filters 32 are formed of resin materials which are colored in, e.g. red, green and blue. Boundaries between the color filters 32 of different colors are located at positions overlapping the light-shield layer 31 above the source lines S.

The overcoat layer 33 covers the color filters 32. The overcoat layer 33 planarizes asperities on the surfaces of the light-shield layer 31 and color filters 32. The overcoat layer 33 is formed of, for example, a transparent resin material. The overcoat layer 33 is covered with the second alignment film AL2. The first alignment film AL1 and second alignment film AL2 are formed of a material which exhibits horizontal alignment properties. In addition, the first alignment film AL1 and second alignment film AL2 are subjected to alignment treatment in mutually parallel directions in a plane which is parallel to the substrate major surface (or X-Y plane).

The above-described array substrate AR and counter-substrate CT are disposed such that their first alignment film AL1 and second alignment film AL2 are opposed to each other. In this case, a predetermined cell gap is created between the array substrate AR and the counter-substrate CT by columnar spacers (spacers SA and peripheral spacers SB) which are formed on one of the array substrate AR and counter-substrate CT. The array substrate AR and counter-substrate CT are attached by a sealant in the state in which the cell gap is created therebetween. The liquid crystal layer LQ is composed of a liquid crystal composition including liquid crystal molecules which are sealed in the cell gap created between the first alignment film AL1 and the second alignment film AL2.

A backlight BL is disposed on the back side of the liquid crystal display panel LPN having the above-described structure. Various modes are applicable to the backlight BL. As the backlight BL, use may be made of either a backlight which utilizes a light-emitting diode (LED) as a light source, or a backlight which utilizes a cold cathode fluorescent lamp (CCFL) as a light source. A description of the detailed structure of the backlight BL is omitted.

A first optical element OD1 including a first polarizer PL1 is disposed on an outer surface of the array substrate AR, that is, an outer surface 10B of the first insulative substrate 10. In addition, a second optical element OD2 including a second polarizer PL2 is disposed on an outer surface of the counter-substrate CT, that is, an outer surface 30B of the second insulative substrate 30. The first polarizer PL1 and second polarizer PL2 are arranged so as to realize a normally black mode which displays black in an OFF state in which no electric field is applied between the pixel electrode PE and common electrode CE. For example, in the OFF state, under a condition that linearly polarized light, which passes through the liquid crystal layer LQ, is not modulated by the liquid crystal layer LQ, the first polarizer PL1 and second polarizer PL2 are arranged in such a positional relationship of crossed Nicols that their polarization axes are perpendicular to each other.

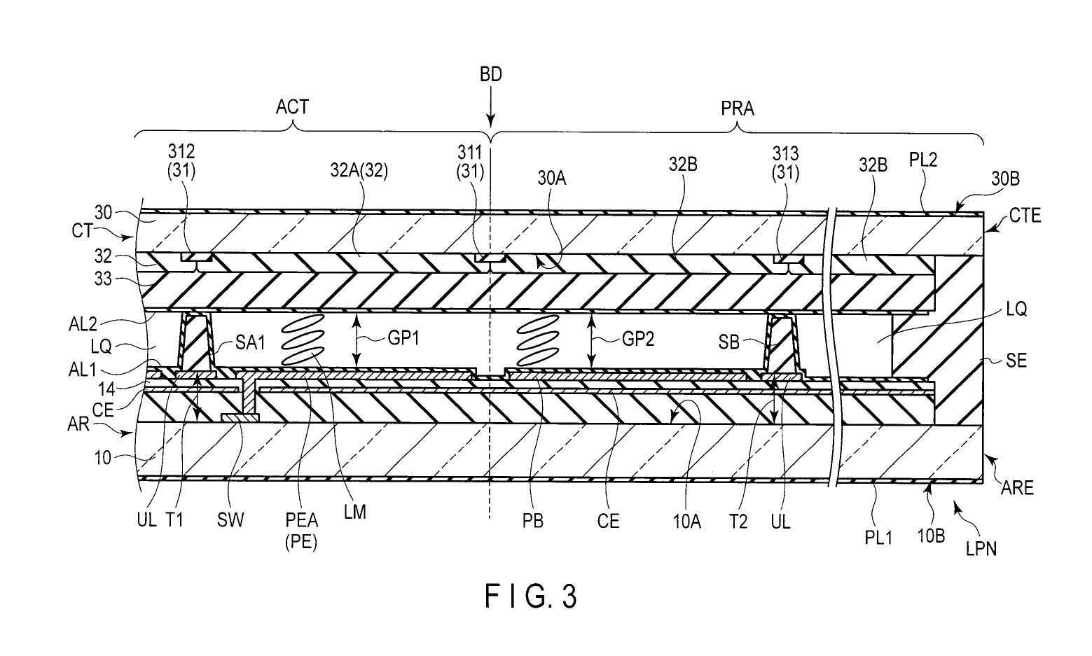

FIG. 3 is a cross-sectional view which schematically illustrates a structure including the spacer SA and peripheral spacer SB in the embodiment. FIG. 3 illustrates only the structure which is necessary for the description.

In the array substrate AR, the common electrode CE extends over the active area ACT and peripheral area PRA. The fourth insulation film 14 is disposed on the common electrode CE. Each pixel electrode PE disposed in the active area ACT is electrically connected to the switching element SW. Needless to say, a pixel electrode PEA illustrated, which is disposed at the outermost periphery of the active area ACT, is similarly electrically connected to the switching element SW. A dummy pixel electrode PB is disposed in the peripheral area PRA. The dummy pixel electrode PB illustrated neighbors the pixel electrode PEA at the outermost periphery, with a distance provided therebetween. The dummy pixel electrode PB is not connected to the switching element, and is in an electrically floating state. The pixel electrodes PE including the pixel electrode PEA, and the dummy pixel electrode PB are formed on the fourth insulation film 14 and are formed of the same material.

In the example illustrated, each of the spacer SA and peripheral spacer SB is formed on the array substrate AR. In addition, the spacer SA and peripheral spacer SB are formed on underlayers UL. The underlayers UL are formed of a material having high adhesion to the resin material of which the spacer SA and peripheral spacer SB are formed. For example, the underlayers UL are formed of ITO. Incidentally, the underlayer UL is formed in an island shape, and is in an electrically floating state. Each of the spacer SA and peripheral spacer SB has a bottom surface in contact with the underlayer UL, and extends towards the counter-substrate CT. The spacer SA and peripheral spacer SB are substantially equal in height.

Each of a total thickness T1 of an underlying base layer of the spacer SA and a total thickness T2 of an underlying base layer of the peripheral spacer SB is a thickness from the inner surface 10A of the first insulative substrate 10 to the surface of the underlayer UL, and the total thickness T1 and total thickness T2 are substantially equal. For example, the stacked state of the first to fourth insulation films may be made identical between the active area ACT and the peripheral area PRA, or a dummy switching element having the same structure as the switching element SW of the active area ACT may be disposed in the peripheral area PRA (the dummy switching element and the dummy pixel electrode, however, are not electrically connected).

The pixel electrodes PE of the active area ACT including the pixel electrode PEA at the outermost periphery, the dummy pixel electrode PB of the peripheral area PRA, the spacer SA and the peripheral spacer SB are covered with the first alignment film AL1. An end portion of the first alignment film AL1 is located on the inner side of a substrate end portion ARE of the array substrate AR, and is located in the inside of the sealant SE. The first alignment film AL1 and sealant SE overlap, for example, over a width of about 50 μm.

At least the first polarizer PL1 of the first optical element OD1, which is disposed on the outer surface 10B, extends to the substrate end portion ARE.

When attention is paid to the structure of this array substrate AR, a boundary BD between the active area ACT and the peripheral area PRA corresponds to a position between the pixel electrode PEA at the outermost periphery of the active area and the dummy pixel electrode PB which neighbors this pixel electrode PEA.

On the other hand, in the counter-substrate CT, a light-shield layer 31 is formed on an inner surface 30A of the second insulative substrate 30 in the active area ACT and peripheral area PRA. In the example illustrated, the light-shield layer 31 includes a first light-shield portion 311, a second light-shield portion 312 and a third light-shield portion 313. As will be described later, the light-shied layer 31 is formed in a grid shape, and is continuous in the active area ACT and peripheral area PRA. Specifically, the first light-shield portion 311, second light-shield portion 312 and third light-shield portion 313 are made continuous at positions (not shown) by other light-shield portions which cross these light-shield portions.

The first light-shield portion 311 is located at the boundary BD and is opposed to a position between the pixel electrode PEA and dummy pixel electrode PB. The second light-shield portion 312 is located in the active area ACT, and is located inside the first light-shield portion 311. The third light-shield portion 313 is located in the peripheral area PRA, and is located outside the first light-shield portion 311. In the example illustrated, one second light-shield portion 312 and one third light-shield portion 313 are disposed. In this example, it is assumed that the entirety of the light-shield portion located in the active area ACT is referred to as the second light-shield portion 312, and the entirety of the light-shield portion located in the peripheral area PRA is referred to as the third light-shield portion 313.

As has been described above, in the active area ACT, the color filters 32 are disposed. Each color filter 32 is opposed to the pixel electrode PE. A color filter 32A, which is located at the outermost periphery of the active area ACT, is opposed to the pixel electrode PEA. The color filter 32A has one end overlapping the first light-shield portion 311, and has the other end overlapping the second light-shield portion 312 which neighbors the first light-shield portion 311.

In the peripheral area PRA, dummy color filters 32B are disposed. Each dummy color filter 32B is opposed to the dummy pixel electrode PB. The dummy color filter 32B is formed of the same material as the color filter 32. For example, while the color filters 32 include the red color filter, green color filter and blue color filter, the dummy color filters 32B may also include a red color filter, a green color filter and a blue color filter, or may be composed of only a blue color filter having a relatively low transmittance. The dummy color filter 32B, which neighbors the color filter 32A, has one end overlapping the first light-shield portion 311, and has the other end overlapping the third light-shield portion 313 which neighbors the first light-shield portion 311. Specifically, the color filter 32A, which is located at the outermost periphery of the active area ACT, and the dummy color filter 32B on the innermost side of the peripheral area PRA (i.e. at a position neighboring the active area) overlap the first light-shield portion 311. Thus, the boundary between the color filter 32A and the dummy color filter 32B is located at a position overlapping the first light-shield portion 311.

The overcoat layer 33 covers the color filter 32 and dummy color filter 32B. The second alignment film AL2 covers the overcoat layer 33 and is opposed to the first alignment film AL1. Each of an end portion of the dummy color filter 32B at the outermost periphery of the peripheral area PRA, an end portion of the second alignment film AL2 and an end portion of the overcoat layer 33 is located on the inner side of a substrate end portion CTE of the counter-substrate CT, and is located in the inside of the sealant SE. The dummy color filter 32B, overcoat layer 33, second alignment film AL2 and sealant SE overlap, for example, over a width of about 50 μm.

At least the second polarizer PL2 of the second optical element OD2, which is disposed on the outer surface 30B, extends to the substrate end portion CTE.

When attention is paid to the structure of this counter-substrate CT, a boundary BD between the active area ACT and the peripheral area PRA corresponds to a position where the first light-shield portion 311 is formed, or corresponds to a boundary between the color filter 32A located at the outermost periphery of the active area ACT and the dummy color filter 32B which neighbors this color filter 32A.

The spacer SA is formed at a position opposed to the second light-shield portion 312. In the example illustrated, the spacer SA is located immediately below the second light-shield portion 312, and supports the counter-substrate CT. The color filter 32, overcoat layer 33, first alignment film AL1 and second alignment film AL2 are interposed between the spacer SA and second light-shield portion 312. The spacer SA creates a substantially uniform cell gap GP1 between the array substrate AR and counter-substrate CT in substantially the entirety of the active area ACT.

The peripheral spacer SB is formed at a position opposed to the third light-shield portion 313. In the example illustrated, the peripheral spacer SB is located immediately below the third light-shield portion 313, and supports the counter-substrate CT. The dummy color filter 32B, overcoat layer 33, first alignment film AL1 and second alignment film AL2 are interposed between the peripheral spacer SB and third light-shield portion 313. The peripheral spacer SB creates a substantially uniform cell gap GP2 between the array substrate AR and counter-substrate CT in substantially the entirety of the peripheral area PRA. The cell gap GP2 is equal to the cell gap GP1 of the active area ACT.

Specifically, in the array substrate AR, the underlying base layers of the spacer SA and peripheral spacer SB have the same structure and are equal in total thickness. In the meantime, in the case of the narrow picture frame specifications, there is a tendency that the density of wirings and circuits increases in the peripheral area PRA. However, at least in the underlying base layer part of the peripheral spacer SB is configured such that the total thickness T2 thereof is equal to the total thickness T1 of the underlying base layer part of the spacer SA.

On the other hand, in the counter-substrate CT, the active area ACT and peripheral area PRA have the same structure. In particular, the structure of the part which is supported by the spacer SA (i.e. the multilayer structure of the second light-shield portion 312, color filter 32 and overcoat layer 33) is identical to the structure of the part which is supported by the peripheral spacer SB (i.e. the multilayer structure of the third light-shield portion 313, dummy color filter 32B and overcoat layer 33).

When the array substrate AR and counter-substrate CT are attached, the spacer SA and peripheral spacer SB, which have equal height, are interposed between the array substrate AR and counter-substrate CT. Thus, a cell gap, which is equal between the active area ACT and the peripheral area PRA, can be created.

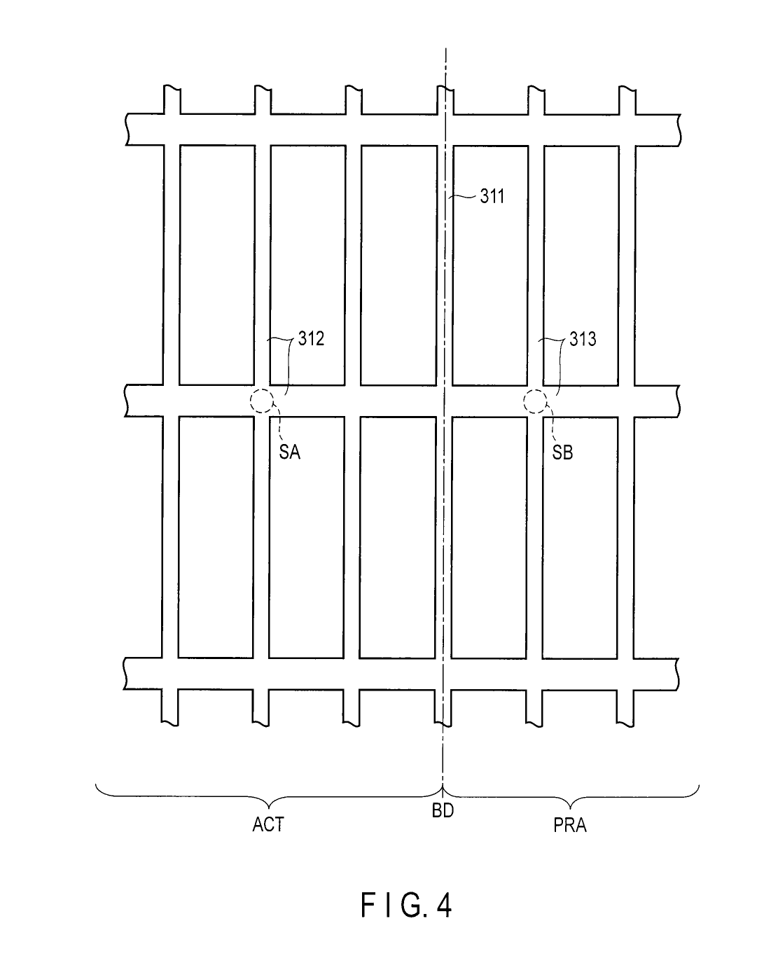

FIG. 4 is a plan view which schematically illustrates a layout example of the light-shield layer 31 which is applicable to the embodiment.

The light-shield layer 31 extends in the first direction X so as to be opposed to gate lines (not shown), etc. extending in the first direction X, extends in the second direction Y so as to be opposed to source lines (not shown), etc. extending in the second direction Y, and is formed in a grid shape in the active area ACT and peripheral area PRA. That portion of the light-shield layer 31, which overlaps the boundary BD, corresponds to the first light-shield portion 311, that portion of the light-shield layer 31, which forms a grid shape in the active area ACT, corresponds to the second light-shield portion 312, and that portion of the light-shield layer 31, which forms a grid shape in the peripheral area PRA, corresponds to the third light-shield portion 313.

Color filters or dummy color filters, which are not illustrated, are disposed in inside parts partitioned by the light-shield layer 31. The spacer SA of the active area ACT and the peripheral spacer SB of the peripheral area PRA are located, for example, near intersections of the light-shield layer 31.

In the liquid crystal display device with the above-described structure, in an OFF state in which no potential difference is produced between the pixel electrode PE and common electrode CE (a state in which no voltage is applied to the liquid crystal layer LQ), since no electric field is produced between the pixel electrode PE and the common electrode CE, liquid crystal molecules included in the liquid crystal layer LQ are initially aligned in an alignment treatment direction of the first alignment film AL1 and second alignment film AL2 in an X-Y plane. At this time, linearly polarized light, which is part of light from the backlight BL, passes through the first polarizer PL1 and enters the liquid crystal display panel LPN. The polarization state of the linearly polarized light, which enters the liquid crystal display panel LPN, hardly varies when the light passes through the liquid crystal layer LQ. Thus, the linearly polarized light, which has passed through the liquid crystal display panel LPN, is absorbed by the second polarizer PL2 which has a positional relationship of crossed Nicols with the first polarizer PL1 (black display).

On the other hand, in an ON state in which a potential difference is produced between the pixel electrode PE and common electrode CE (a state in which a voltage is applied to the liquid crystal layer LQ), a fringe electric field is produced between the pixel electrode PE and the common electrode CE. Thus, the liquid crystal molecules are aligned in an azimuth direction different from the initial alignment direction in the X-Y plane, due to the function of the fringe electric field. At this time, the polarization state of linearly polarized light, which has entered the liquid crystal display panel LPN, varies depending on the alignment state of the liquid crystal molecules when the light passes through the liquid crystal layer LQ (or the retardation of the liquid crystal layer). Thus, in the ON state, at least part of the light emerging from the liquid crystal layer LQ passes through the second polarizer PL2 (white display).

In the meantime, regardless of the display state (ON/OFF state) of the active area ACT, the liquid crystal layer LQ of the peripheral area PRA is held between the first alignment film AL1 and second alignment film AL2 and is always kept in the OFF state. Specifically, the liquid crystal molecules of the peripheral area PRA maintain the initial alignment state, and are kept in the black display state by the function of the first polarizer PL1 and second polarizer PL2 which extend in the peripheral area PRA.

According to the present embodiment, the cell gap in the peripheral area PRA can be made equal to the cell gap in the active area ACT. Thus, even in the case of the narrow picture frame specifications with the picture frame width of less than 1 mm, the uniform cell gap GP1 can be created over the entire active area ACT, without being affected by the cell gap of the peripheral area PRA. Therefore, it is possible to suppress the occurrence of non-uniformity in display due to the variance of the cell gap, or to improve the uniformity of the display quality.

In addition, the first polarizer PL1 and second polarizer PL2 are disposed to extend over not only the active area ACT but also the peripheral area PRA, and to overlap the sealant SE. Thereby, a normally black mode is realized which displays black in the OFF state in which no electric field is applied between the pixel electrode PE and common electrode CE. Thus, even if the light-shield layer 31 of the peripheral area PRA is formed in a grid shape, like the active area ACT, light leak in the peripheral area PRA can be suppressed since the peripheral area PRA is kept in the black display state. In particular, from the standpoint of suppression of light leak in the peripheral area PRA, it is desirable that the first polarizer PL1 and second polarizer PL2 extend to the substrate ends of the array substrate AR and counter-substrate CT. Incidentally, it is not necessary for the first polarizer PL1 to extend to that area of the array substrate AR, which does not overlap the counter-substrate CT.

Furthermore, since the cell gap can be made uniform in the active area ACT and peripheral area PRA, when the ODF method is applied as the manufacturing method, the volume of the liquid crystal space, in which the liquid crystal material is to be sealed, can be substantially kept at a preset value, and a proper amount of liquid crystal material can be sealed. It is thus possible to suppress the occurrence of excess/deficiency of the liquid crystal material due to the variance in volume of the liquid crystal space, to suppress the variance in cell gap due to the excess/deficiency of the liquid crystal material, and to suppress the occurrence of non-uniformity in display in the active area. Therefore, the degradation in display quality and the decrease in manufacturing yield can be suppressed.

In the case of the high fineness/narrow picture frame specifications, the ratio of the area of the peripheral area PRA to the area of the active area ACT is very small, and the picture frame width is also very small. Thus, even in the combination of the grid-shaped light-shield layer 31 and dummy color filter 32B, the visibility of a color of the dummy color filter 32B in the peripheral area PRA is very low, and the effect on the display quality of the active area ACT can be decreased.

In the structure of a comparative example, a solid light-shield layer 31 is disposed over the entire peripheral area PRA. It was confirmed that in the case of the structure in which the light-shield layer 31 and overcoat layer 33 are stacked, the cell gap becomes smaller than in the active area ACT, and that in the case of the structure in which the light-shield layer 31, color filter 32 and overcoat layer 33 are stacked, the cell gap becomes larger than in the active area ACT. In each case, in the narrow picture frame specifications, the cell gap of the peripheral portion in the active area ACT was non-uniform due to the effect of the cell gap of the peripheral area PRA, and a display defect occurred.

Next, other structure examples of the embodiment will be described.

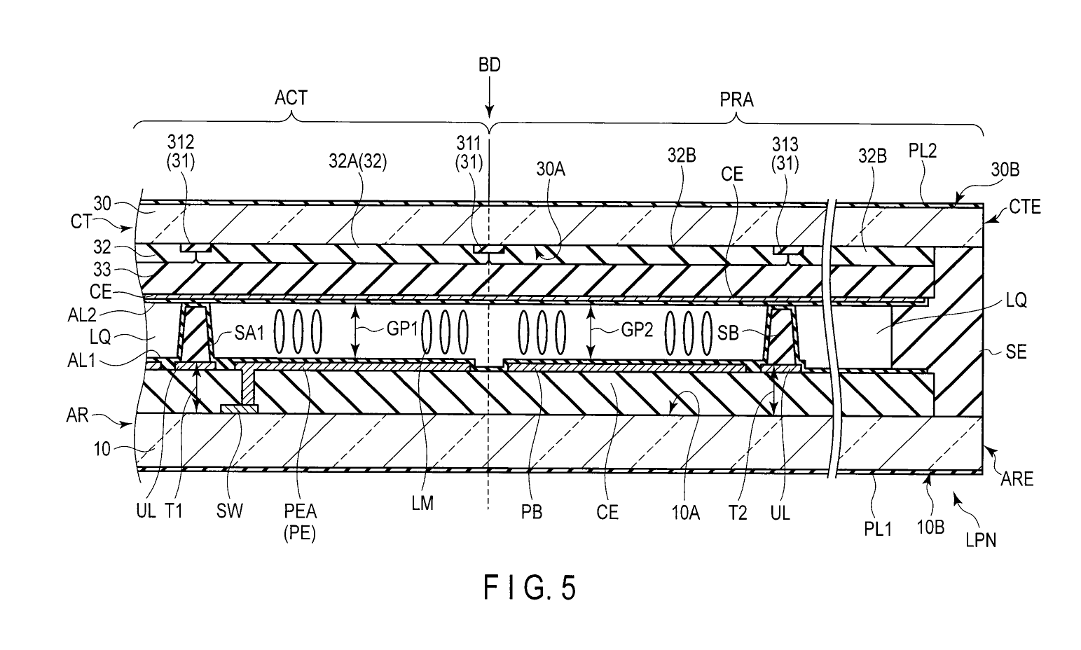

FIG. 5 is a cross-sectional view which schematically illustrates another structure including a spacer SA and a peripheral spacer SB in the embodiment. FIG. 5 illustrates only the structure which is necessary for the description.

The structure example illustrated in FIG. 5 differs from the structure example shown in FIG. 3 in that the common electrode CE is provided in the counter-substrate CT. Specifically, the overcoat layer 33 covers the color filters 32 and dummy color filter 32B. The common electrode CE is formed on that side of the overcoat layer 33, which is opposed to the array substrate AR. In addition, the common electrode CE extends over the active area ACT and peripheral area PRA. The second alignment film AL2 covers the common electrode CE in the active area ACT and peripheral area PRA.

In this structure, the first alignment film AL1 and second alignment film AL2 are formed of, for example, a material which exhibits vertical alignment properties. In addition, no alignment treatment is needed for the first alignment film AL1 and second alignment film AL2.

In the liquid crystal display device with the above-described structure, in the OFF state in which no potential difference is produced between the pixel electrode PE and common electrode CE, the liquid crystal molecules LM included in the liquid crystal layer LQ are initially aligned in a direction vertical to the major surfaces of the first alignment film AL1 and second alignment film AL2. At this time, since the polarization state of the linearly polarized light, which enters the liquid crystal display panel LPN, hardly varies when the light passes through the liquid crystal layer LQ, the linearly polarized light, which has passed through the liquid crystal display panel LPN, is absorbed by the second polarizer PL2 which has a positional relationship of crossed Nicols with the first polarizer PL1 (black display).

On the other hand, in the ON state in which a potential difference is produced between the pixel electrode PE and common electrode CE, a vertical electric field is produced between the pixel electrode PE and the common electrode CE. The negative-type liquid crystal molecules LM are aligned in an azimuth direction different from the initial alignment direction due to the function of the vertical electric field. At this time, the polarization state of linearly polarized light, which has entered the liquid crystal display panel LPN, varies depending on the alignment state of the liquid crystal molecules when the light passes through the liquid crystal layer LQ. Thus, in the ON state, at least part of the light emerging from the liquid crystal layer LQ passes through the second polarizer PL2 (white display).

In this structure example, too, the cell gap in the peripheral area PRA and the cell gap in the active area ACT can be made equal, and the same advantageous effects as in the structure example shown in FIG. 3 can be obtained.

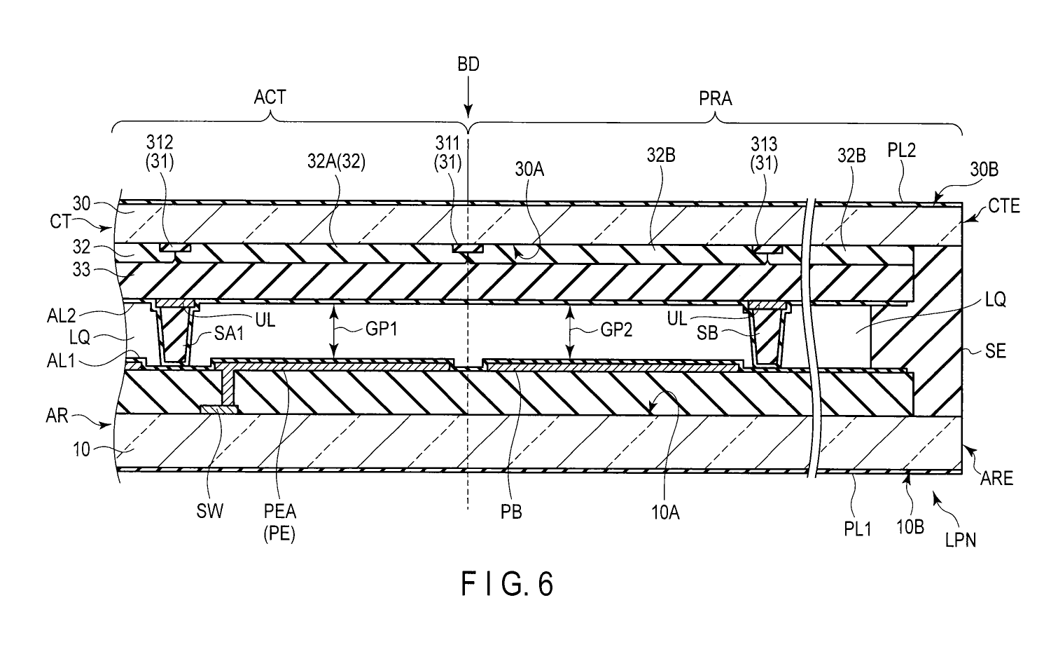

FIG. 6 is a cross-sectional view which schematically illustrates another structure including a spacer SA and a peripheral spacer SB in the embodiment. FIG. 6 illustrates only the structure which is necessary for the description.

In FIG. 6, although the depiction of the common electrode CE is omitted, the common electrode CE may be provided in the array substrate AR, like the structure example shown in FIG. 3, or may be provided in the counter-substrate CT, like the structure example shown in FIG. 5.

The structure example illustrated in FIG. 6 differs from the structure examples shown in FIG. 3 and FIG. 5 in that both the spacer SA and the peripheral spacer SB are formed on the counter-substrate CT. In addition, the spacer SA and the peripheral spacer SB are stacked on underlayers UL and are covered with the second alignment film AL2. The underlayers UL are formed on that surface of the overcoat layer 33, which is opposed to the array substrate AR. The details of the underlayer UL are the same as in the example shown in FIG. 3, and a description is omitted. Each of the spacer SA and peripheral spacer SB has a bottom surface in contact with the underlayer UL, and extends towards the array substrate AR. The spacer SA and peripheral spacer SB are substantially equal in height, and support the array substrate AR.

Specifically, the spacer SA creates a substantially uniform cell gap GP1 between the array substrate AR and counter-substrate CT in the active area ACT. The peripheral spacer SB creates a substantially uniform cell gap GP2 between the array substrate AR and counter-substrate CT in the peripheral area PRA. The cell gap GP2 is equal to the cell gap GP1.

In this structure example, too, the same advantageous effects as in the structure example shown in FIG. 3 can be obtained.

The structure of the counter-substrate CT illustrated here is merely an example, and is not limited to this illustrated example.

As has been described above, according to the present embodiment, a liquid crystal display device, which can uniformize the cell gap, can be provided.

In the structure of the above-described embodiment, a sealant is disposed with no break on one of the substrates in a manner to surround the active area, and after a liquid crystal material is dispensed by an ODF method, the paired substrates are attached. However, the structure is not limited to this example. For example, a sealant may be disposed on one of the substrates in a manner to surround the active area while forming a liquid crystal filling port, and the paired substrates may be attached by a vacuum filling method.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a first substrate including a pixel electrode disposed at an outermost periphery in an active area which displays an image, a dummy pixel electrode disposed in a peripheral area outside the active area and neighboring the pixel electrode, and a first alignment film covering the pixel electrode and the dummy pixel electrode;
a second substrate including a light-shield layer including a first light-shield portion located at a boundary between the active area and the peripheral area and opposed to a position between the pixel electrode and the dummy pixel electrode, a second light-shield portion located in the active area and a third light-shield portion located in the peripheral area, a color filter opposed to the pixel electrode, a dummy color filter opposed to the dummy pixel electrode, and a second alignment film opposed to the first alignment film;
a first columnar spacer which is interposed between the first substrate and the second substrate in the active area, creates a first cell gap in the active area, and is formed at a position opposed to the second light-shield portion;
a second columnar spacer which is interposed between the first substrate and the second substrate in the peripheral area, creates a second cell gap that is equal to the first cell gap in the peripheral area, and is formed at a position opposed to the third light-shield portion; and
a liquid crystal layer held between the first substrate and the second substrate.

2. The liquid crystal display device of claim 1, further comprising a first polarizer disposed on an outer surface of the first substrate and extending to an end portion of the first substrate, and a second polarizer which is disposed on an outer surface of the second substrate, extends to an end portion of the second substrate, and has a positional relationship of crossed Nicols with the first polarizer.

3. The liquid crystal display device of claim 1, wherein the light-shield layer is formed in a grid shape in the active area and the peripheral area.

4. The liquid crystal display device of claim 1, wherein a part of the color filter and a part of the dummy color filter overlap the first light-shield portion.

5. The liquid crystal display device of claim 1, wherein the dummy color filter is a blue color filter.

6. The liquid crystal display device of claim 1, wherein the first columnar spacer and the second columnar spacer are formed on an identical substrate which is either the first substrate or the second substrate.

7. The liquid crystal display device of claim 1, wherein a width of the peripheral area is less than 1 mm.

8. A liquid crystal display device comprising:
a first substrate including a common electrode extending over an active area which displays an image and a peripheral area outside the active area, an interlayer insulation film located above the common electrode, a pixel electrode disposed above the interlayer insulation film at an outermost periphery in the active area, a dummy pixel electrode disposed above the interlayer insulation film in the peripheral area and neighboring the pixel electrode, and a first alignment film covering the pixel electrode and the dummy pixel electrode;
a second substrate including a light-shield layer including a first light-shield portion located at a boundary between the active area and the peripheral area and opposed to a position between the pixel electrode and the dummy pixel electrode, a second light-shield portion located in the active area and a third light-shield portion located in the peripheral area, a color filter opposed to the pixel electrode, a dummy color filter opposed to the dummy pixel electrode, and a second alignment film opposed to the first alignment film;
a first columnar spacer which is interposed between the first substrate and the second substrate in the active area, creates a first cell gap in the active area, and is formed at a position opposed to the second light-shield portion;
a second columnar spacer which is interposed between the first substrate and the second substrate in the peripheral area, creates a second cell gap that is equal to the first cell gap in the peripheral area, and is formed at a position opposed to the third light-shield portion; and
a liquid crystal layer held between the first substrate and the second substrate.

9. The liquid crystal display device of claim 8, further comprising a first polarizer disposed on an outer surface of the first substrate and extending to an end portion of the first substrate, and a second polarizer which is disposed on an outer surface of the second substrate, extends to an end portion of the second substrate, and has a positional relationship of crossed Nicols with the first polarizer.

10. The liquid crystal display device of claim 8, wherein the light-shield layer is formed in a grid shape in the active area and the peripheral area.

11. The liquid crystal display device of claim 8, wherein a part of the color filter and a part of the dummy color filter overlap the first light-shield portion.

12. The liquid crystal display device of claim 8, wherein the dummy color filter is a blue color filter.

13. The liquid crystal display device of claim 8, wherein the first columnar spacer and the second columnar spacer are formed on an identical substrate which is either the first substrate or the second substrate.

14. A liquid crystal display device comprising:
a first substrate including a pixel electrode disposed at an outermost periphery in an active area which displays an image, a dummy pixel electrode disposed in a peripheral area outside the active area and neighboring the pixel electrode, and a first alignment film covering the pixel electrode and the dummy pixel electrode;
a second substrate including a light-shield layer including a first light-shield portion located at a boundary between the active area and the peripheral area and opposed to a position between the pixel electrode and the dummy pixel electrode, a second light-shield portion located in the active area and a third light-shield portion located in the peripheral area, a color filter opposed to the pixel electrode, a dummy color filter opposed to the dummy pixel electrode, an overcoat layer covering the color filter and the dummy color filter, a common electrode formed on a side of the overcoat layer, which is opposed to the first substrate, and extending over the active area and the peripheral area, and a second alignment film opposed to the first alignment film and covering the common electrode;
a first columnar spacer which is interposed between the first substrate and the second substrate in the active area, creates a first cell gap in the active area, and is formed at a position opposed to the second light-shield portion;
a second columnar spacer which is interposed between the first substrate and the second substrate in the peripheral area, creates a second cell gap that is equal to the first cell gap in the peripheral area, and is formed at a position opposed to the third light-shield portion; and
a liquid crystal layer held between the first substrate and the second substrate.

15. The liquid crystal display device of claim 14, further comprising a first polarizer disposed on an outer surface of the first substrate and extending to an end portion of the first substrate, and a second polarizer which is disposed on an outer surface of the second substrate, extends to an end portion of the second substrate, and has a positional relationship of crossed Nicols with the first polarizer.

16. The liquid crystal display device of claim 14, wherein the light-shield layer is formed in a grid shape in the active area and the peripheral area.

17. The liquid crystal display device of claim 14, wherein a part of the color filter and a part of the dummy color filter overlap the first light-shield portion.

18. The liquid crystal display device of claim 14, wherein the dummy color filter is a blue color filter.

19. The liquid crystal display device of claim 14, wherein the first columnar spacer and the second columnar spacer are formed on an identical substrate which is either the first substrate or the second substrate.

20. The liquid crystal display device of claim 14, wherein the first alignment film and the second alignment film are formed of a material which exhibits vertical alignment properties.
